(19) United States
(12) Patent Application Publication
(10) Pub. No.: US 2023/0003753 A1
(43) Pub. Date: Jan. 5, 2023

(54) SYSTEMS AND METHODS FOR MANAGING EXPERIMENTAL REQUESTS AT REMOTE LABORATORIES

(71) Applicant: STRATEOS, INC., Menlo Park, CA (US)

(72) Inventors: Sayagoud Ramu Phanimukla, Pleasanton, CA (US); Vanessa Biggers, San Francisco, CA (US); Alok Gupta, San Ramon, CA (US); Venkat Eswarakrishnan, Fremont, CA (US)

(21) Appl. No.: 17/854,711

(22) Filed: Jun. 30, 2022

Related U.S. Application Data
(60) Provisional application No. 63/218,267, filed on Jul. 2, 2021.

(51) Int. Cl. G01N 35/00; G06Q 10/06

(52) U.S. Cl. CPC G01N 35/00871; G06Q 10/06311

(57) ABSTRACT

System and method for managing one or more experimental requests. For example, the method includes receiving multiple experimental requests, determining a schedule for executing the multiple experimental requests based upon attributes associated with each experimental request, and assigning the multiple experimental requests to remote laboratories for execution based upon the schedule and features of the remote laboratories.

### CROSS-REFERENCE TO RELATED APPLICATIONS

This application claims priority to U.S. Provisional Patent Application No. 63/218,267, filed Jul. 2, 2021, which is incorporated by reference herein for all purposes.

The following four applications, including this one, are being filed concurrently and the other applications are hereby incorporated by reference in their entirety for all purposes:

1. U.S. patent application Ser. No. ______, titled “Systems and Methods for Processing Experimental Workflows at Remote Laboratories” (Attorney Docket Number 520295.000014); and

2. U.S. patent application Ser. No. ______, titled “Systems and Methods for Managing Experimental Requests at Remote Laboratories” (Attorney Docket Number 520295.000015).

3. U.S. patent application Ser. No. ______, titled “Systems and Methods for Processing Experimental Requests at Remote Laboratories” (Attorney Docket Number 520295.000016).

4. U.S. patent application Ser. No. ______, titled “Systems and Methods for Performing Experiments at Remote Laboratories” (Attorney Docket Number 520295.000017).

### FIELD OF THE DISCLOSURE

Some embodiments of the present disclosure are directed to managing experimental requests. More particularly, certain embodiments of the present disclosure provide systems and methods for scheduling multiple experimental requests. Merely by way of example, the present disclosure has been applied to assigning the scheduled multiple experimental requests for execution at a remote laboratory. But it would be recognized that the present disclosure has much broader range of applicability.

### BACKGROUND OF THE DISCLOSURE

Experiments performed at designated laboratories are limited by existing infrastructure. Remote laboratories, on the other hand, provide the opportunity to carry out different experiments with different scope at the same time. Accordingly, there exists a need to develop techniques that can enable users to scale to remote laboratory infrastructures when needing capability and/or capacity.

### BRIEF SUMMARY OF THE DISCLOSURE

Some embodiments of the present disclosure are directed to managing experimental requests. More particularly, certain embodiments of the present disclosure provide systems and methods for scheduling multiple experimental requests. Merely by way of example, the present disclosure has been applied to assigning the scheduled multiple experimental requests for execution at a remote laboratory. But it would be recognized that the present disclosure has much broader range of applicability.

According to certain embodiments, a method for managing one or more experimental requests includes receiving multiple experimental requests. Also, the method includes determining a schedule for executing the multiple experimental requests based at least in part upon one or more attributes associated with each experimental request of the multiple experimental requests. Moreover, the method includes assigning the multiple experimental requests to one or more remote laboratories for execution based at least in part upon the schedule and one or more features of the one or more remote laboratories.

According to some embodiments, a system for managing one or more experimental requests includes one or more processors and a memory storing instructions for execution by the one or more processors. The instructions, when executed by the one or more processors, cause the system to receive multiple experimental requests. Also, the instructions, when executed by the one or more processors, cause the system to determine a schedule for executing the multiple experimental requests based at least in part upon one or more attributes associated with each experimental request of the multiple experimental requests. Moreover, the instructions, when executed by the one or more processors, cause the system to assign the multiple experimental requests to one or more remote laboratories for execution based at least in part upon the schedule and one or more features of the one or more remote laboratories.

According to certain embodiments, a non-transitory computer-readable medium stores instructions for managing one or more experimental requests. The instructions are executed by one or more processors of a computing device. The non-transitory computer-readable medium includes instructions to receive multiple experimental requests. Also, the non-transitory computer-readable medium includes instructions to determine a schedule for executing the multiple experimental requests based at least in part upon one or more attributes associated with each experimental request of the multiple experimental requests. Moreover, the non-transitory computer-readable medium includes instructions to assign the multiple experimental requests to one or more remote laboratories for execution based at least in part upon the schedule and one or more features of the one or more remote laboratories.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 shows a simplified method for managing experimental requests according to certain embodiments of the present disclosure.

FIG. 2 shows a simplified system for managing experimental requests according to certain embodiments of the present disclosure.

FIG. 3 shows a simplified diagram illustrating various modules for managing experimental requests according to certain embodiments of the present disclosure.

### DETAILED DESCRIPTION OF THE DISCLOSURE

Some embodiments of the present disclosure are directed to managing experimental requests. More particularly, certain embodiments of the present disclosure provide systems and methods for scheduling multiple experimental requests. Merely by way of example, the present disclosure has been applied to assigning the scheduled multiple experimental requests for execution at a remote laboratory. But it would be recognized that the present disclosure has much broader range of applicability.

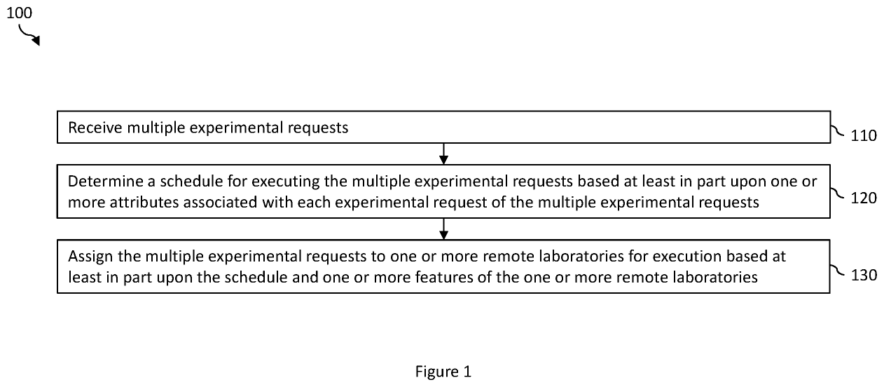

FIG. 1 shows a simplified method for managing experimental requests according to certain embodiments of the present disclosure. This figure is merely an example, which should not unduly limit the scope of the claims. One of ordinary skill in the art would recognize many variations, alternatives, and modifications. The method 100 includes process 110 for receiving experimental requests, process 120 for scheduling the experimental requests, and process 130 for assigning the experimental requests for execution. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 110, multiple experimental requests are received according to certain embodiments. In some embodiments, one or more attributes associated with each experimental request are received. For example, the one or more attributes include a target delivery date, a predicted execution duration, human resources needed, robotic resources needed, and/or financial resources needed. In certain embodiments, the one or more attributes are customized per experimental request and/or per customer. In some embodiments, the multiple experimental requests are published along with the status of each experimental request and the one or more attributes associated with each experimental request. In certain embodiments, the multiple experimental requests are published in a prioritized order. In some embodiments, each received experimental request is created using a template.

At the process 120, a schedule for executing the multiple experimental requests based at least in part upon the one or more attributes associated with each experimental request is determined according to certain embodiments. In some embodiments, the schedule includes an order to execute each experimental request. In certain embodiments, the schedule includes a desired time slot to execute each experimental request.

At the process 130, the multiple experimental requests are assigned to one or more remote laboratories for execution based at least in part upon the schedule and one or more features of the one or more remote laboratories according to certain embodiments. In some embodiments, the one or more features of the one or more remote laboratories include capabilities of the one or more remote laboratories, capacities of the one or more remote laboratories, and/or current workloads at the one or more remote laboratories. For example, the multiple experimental requests are routed to the one or more remote laboratories based upon the laboratory capabilities, capacities, and/or loads.

In certain embodiments, a user interface is provided to manage (e.g., approve, update, modify, etc.) at least one experimental request of the multiple experimental requests. For example, the user interface is configured to send one or more notifications (e.g., experimental request initiated, experimental request completed, etc.) to a submitter of the at least one experimental request. As an example, the user interface is configured to receive, from the submitter of the at least one experimental request, information associated with resources needed (e.g., human resources, robotic resources, financial resources, etc.) for the at least one experimental request. For example, the user interface is configured to receive, from the submitter of the at least one experimental request, one or more modifications to the at least one experimental request. As an example, the user interface is configured to enable the submitter to place the at least one experiment request in an execution queue.

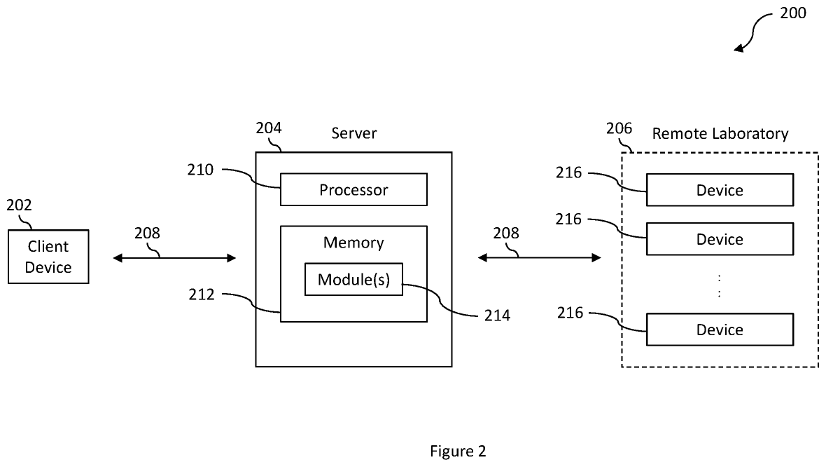

FIG. 2 shows a simplified system for managing experimental requests according to certain embodiments of the present disclosure. This figure is merely an example, which should not unduly limit the scope of the claims. One of ordinary skill in the art would recognize many variations, alternatives, and modifications. The system 200 includes a client device 202, a server 204 and a remote laboratory 206. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the client device 202, the server 204, and the remote laboratory 206 are communicatively coupled to one another via a suitable network 208 (e.g., Internet, mobile communication network, virtual private network, local area network, etc.). In some embodiments, the server 204 is part of or located at the remote laboratory 206. In certain embodiments, multiple remote laboratories 206 exist in the system 200.

In certain embodiments, a user (e.g., a scientist, a researcher, etc.) may use the client device 202 to communicate with the server 204 for managing experimental requests at the remote laboratory 206. For example, the server 204 executes one or more operations to implement the method 100. In some embodiments, the server 204 includes a processor 210 and a memory 212. For example, the processor 210 is configured to execute instructions and/or one or more modules 214 to perform the various operations associated with the method 100. As an example, the instructions and the one or more modules 214 are stored in the memory 212.

In some embodiments, the remote laboratory 206 employs one or more devices 216 to execute the experimental workflow. For example, the one or more devices 216 may include acoustic liquid handlers (e.g., Beckman Echo 650/525, EDC Biosystems ATS), polymerase chain reaction (PCR) machines (e.g., Bio-Rad CFX96, Bio-Rad CFX384, Thermo Fisher 7500 RT), centrifuges (e.g., Bionex HiG 4), reagent dispensers (e.g., Thermo Scientific Multidrop, Formulatrix Tempest), magnetic purification processors (e.g., Thermo Scientific KingFisher Flex Magnetic Particle Processor Magnetic Plate Separation), liquid handling devices (e.g., Agilent Bravo 96w/384w, Tecan ADP, Hamilton Star), flow cytometers (e.g., Attune NxT Acoustic Focusing Cytometer), live cell formats (e.g., cell imaging), Next-generation sequencing (NGS) sequencers (e.g., Pacific Biosciences RS II sequencer, Illumina HiSeq 4000 sequencer), analytical chemistry devices (e.g., Agilent LC/MS Infinity II), and/or synthetic chemistry robotics. In various embodiments, the one or more devices 216 can be combined in any number of ways. In some embodiments, a mix of human and/or robotic laboratory services are provided to manage and process experimental workflows at the remote laboratory 206.

In certain embodiments, the system 200 is employed for various scientific applications and/or research areas (e.g., drug discovery, cancer research, protein engineering, synthetic biology, high throughput screening, bio-chemical assays, medicinal chemistry, personalized medicine, and/or closed-loop machine learning applications).

In various embodiments, any variety of machine learning approaches may be performed on data generated in the system 200 to further inform and guide next steps in experimentation, improve performance, create new experiments, and/or analyze data across previously disparate scientific applications.

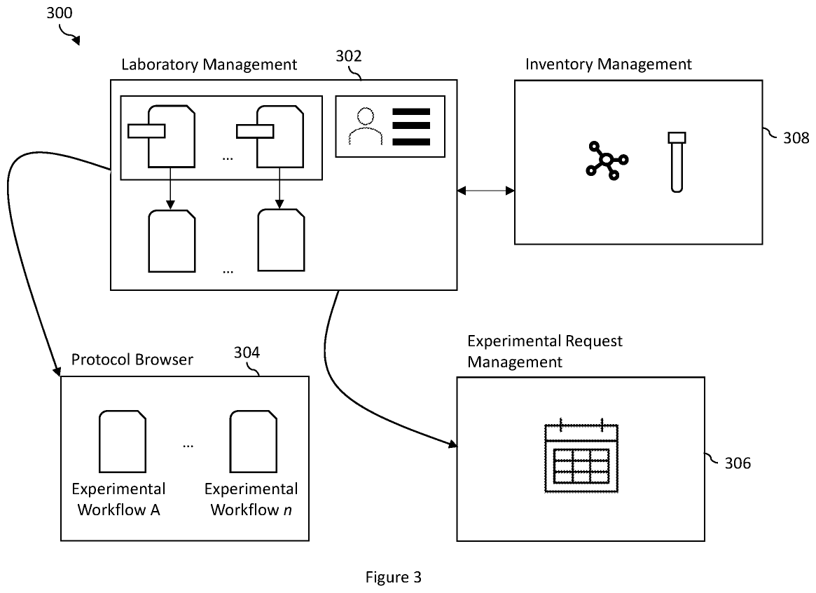

FIG. 3 shows a simplified diagram of various modules for managing experimental requests according to certain embodiments of the present disclosure. This figure is merely an example, which should not unduly limit the scope of the claims. One of ordinary skill in the art would recognize many variations, alternatives, and modifications. The system 300 includes a laboratory management module 302, a protocol browser module 304, an experimental request management module 306, and an inventory management module 308. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, one or more processes are executed by the modules 302-308 for coordinating, planning, scheduling, and/or allocating resources to experimental requests at one or more remote laboratories.

In certain embodiments, the laboratory management module 302, the protocol browser module 304, the experimental request management module 306, and/or the inventory management module 308 are web-based modules. For example, the modules 302-308 are accessible via the Internet. In some embodiments, the modules 302-308 are part of the one or more modules 214 of FIG. 2.

In some embodiments, the laboratory management module 302 includes functionalities to manage users (e.g., add users, delete users, define user groups, etc.) and user roles (e.g., user scope, user access, etc.). In certain embodiments, user roles are customized based upon organization requirements. In some embodiments, the laboratory management module 302 allows a user to add remote laboratories. For example, the user can add a remote laboratory for executing experimental requests available to users or user groups. In certain embodiments, the laboratory management module 302 allows the user to add protocols and/or customize pricing models. In certain embodiments, the laboratory management module 302 receives experimental requests and publishes experimental workflow associated with the experimental requests.

In various embodiments, the laboratory management module 302 manages user access policies, user groups, and/or user roles. In some embodiments, the laboratory management module 302 allows secured access of data based upon a permission model. In certain embodiments, the permission model enables collaboration for sharing of scientific knowledge gained through running experiments across remote laboratories.

In some embodiments, the protocol browser module 304 includes functionalities that enable the user to view information regarding the experimental workflows. For example, the user can view available experimental workflows, version controlled experimental workflows, and/or linked execution history of experimental workflows. In various embodiments, the protocol browser module 302 includes functionalities that allow the user to customize inputs, parameters, and/or validations.

In certain embodiments, the experimental request management module 306 includes functionalities that enable the user to manage and/or schedule the experiment requests. For example, the user can view, approve/reject, and/or assign the experimental requests for execution. In various embodiments, the experimental request management module 306 includes functionalities to assign human, robotic and/or financial resources.

In some embodiments, the inventory management module 308 includes functionalities that enable the user to perform multi-site management, material management, and/or sample tracking and provenance.

According to certain embodiments, a method for managing one or more experimental requests includes receiving multiple experimental requests. Also, the method includes determining a schedule for executing the multiple experimental requests based at least in part upon one or more attributes associated with each experimental request of the multiple experimental requests. Moreover, the method includes assigning the multiple experimental requests to one or more remote laboratories for execution based at least in part upon the schedule and one or more features of the one or more remote laboratories. For example, the method is implemented according to at least FIG. 1.

According to some embodiments, a system for managing one or more experimental requests includes one or more processors and a memory storing instructions for execution by the one or more processors. The instructions, when executed by the one or more processors, cause the system to receive multiple experimental requests. Also, the instructions, when executed by the one or more processors, cause the system to determine a schedule for executing the multiple experimental requests based at least in part upon one or more attributes associated with each experimental request of the multiple experimental requests. Moreover, the instructions, when executed by the one or more processors, cause the system to assign the multiple experimental requests to one or more remote laboratories for execution based at least in part upon the schedule and one or more features of the one or more remote laboratories. For example, the system is implemented according to at least FIG. 2.

According to certain embodiments, a non-transitory computer-readable medium stores instructions for managing one or more experimental requests. The instructions are executed by one or more processors of a computing device. The non-transitory computer-readable medium includes instructions to receive multiple experimental requests. Also, the non-transitory computer-readable medium includes instructions to determine a schedule for executing the multiple experimental requests based at least in part upon one or more attributes associated with each experimental request of the multiple experimental requests. Moreover, the non-transitory computer-readable medium includes instructions to assign the multiple experimental requests to one or more remote laboratories for execution based at least in part upon the schedule and one or more features of the one or more remote laboratories. For example, the non-transitory computer-readable medium is implemented according to at least FIG. 1, FIG. 2, and/or FIG. 3.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In still another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Certain implementations may also be used, however, such as firmware or even appropriately designed hardware configured to perform the methods and systems described herein.

The systems' and methods' data (e.g., associations, mappings, data input, data output, intermediate data results, final data results) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

What is claimed is:

1. A method for managing one or more experimental requests, the method comprising:
receiving multiple experimental requests;
determining a schedule for executing the multiple experimental requests based at least in part upon one or more attributes associated with each experimental request of the multiple experimental requests; and
assigning the multiple experimental requests to one or more remote laboratories for execution based at least in part upon the schedule and one or more features of the one or more remote laboratories.

2. The method of claim 1, wherein the one or more attributes associated with each experimental request include one or more of a target delivery date, a predicted execution duration, human resources needed, and robotic resources needed.

3. The method of claim 1, further comprising:
providing a user interface configured to manage at least one experimental request of the multiple experimental requests.

4. The method of claim 3, wherein providing the user interface configured to manage the at least one experimental request includes:
sending one or more notifications to a submitter of the at least one experimental request.

5. The method of claim 3, wherein providing the user interface configured to manage the at least one experimental request includes:
receiving, from a submitter of the at least one experimental request, information associated with the human resources needed and the robotic resources needed for the at least one experimental request.

6. The method of claim 3, wherein providing the user interface configured to manage the at least one experimental request includes:
receiving, from a submitter of the at least one experimental request, one or more modifications to the at least one experimental request.

7. The method of claim 1, wherein the one or more features of the one or more remote laboratories include at least one selected from a group consisting of capability, capacity, and load at the one or more remote laboratories.

8. A system for managing one or more experimental requests, the system comprising:
one or more processors; and
a memory storing instructions that, when executed by the one or more processors, cause the system to:
receive multiple experimental requests;
determine a schedule for executing the multiple experimental requests based at least in part upon one or more attributes associated with each experimental request of the multiple experimental requests; and
assign the multiple experimental requests to one or more remote laboratories for execution based at least in part upon the schedule and one or more features of the one or more remote laboratories.

9. The system of claim 8, wherein the one or more attributes associated with each experimental request include one or more of a target delivery date, a predicted execution duration, human resources needed, and robotic resources needed.

10. The system of claim 9, wherein the instructions, when executed by the one or more processors, further cause the system to:
provide a user interface configured to manage at least one experimental request of the multiple experimental requests.

11. The system of claim 10, wherein, the instructions that cause the system to provide the user interface configured to manage the at least one experimental request further comprise instructions that cause the system to send one or more notifications to a submitter of the at least one experimental request.

12. The system of claim 10, wherein, the instructions that cause the system to provide the user interface configured to manage the at least one experimental request further comprise instructions that cause the system to receive, from a submitter of the at least one experimental request, information associated with the human resources needed and the robotic resources needed for the at least one experimental request.

13. The system of claim 10, wherein, the instructions that cause the system to provide the user interface configured to manage the at least one experimental request further comprise instructions that cause the system to receive, from a submitter of the at least one experimental request, one or more modifications to the at least one experimental request.

14. The system of claim 8, wherein the one or more features of the one or more remote laboratories include at least one selected from a group consisting of capability, capacity, and load at the one or more remote laboratories.

15. A non-transitory computer-readable medium storing instructions for managing one or more experimental requests, the instructions when executed by one or more processors of a computing device, cause the computing device to:
receive multiple experimental requests;
determine a schedule for executing the multiple experimental requests based at least in part upon one or more attributes associated with each experimental request of the multiple experimental requests; and
assign the multiple experimental requests to one or more remote laboratories for execution based at least in part upon the schedule and one or more features of the one or more remote laboratories.

16. The non-transitory computer-readable medium of claim 15, wherein the one or more attributes associated with each experimental request include one or more of a target delivery date, a predicted execution duration, human resources needed, and robotic resources needed.

17. The non-transitory computer-readable medium of claim 15, wherein, the instructions when executed by the one or more processors further cause the computing device to:
provide a user interface configured to manage at least one experimental request of the multiple experimental requests.

18. The non-transitory computer-readable medium of claim 17, wherein, the instructions when executed by the one or more processors that cause the computing device to provide the user interface configured to manage the at least one experimental request further cause the computing device to send one or more notifications to a submitter of the at least one experimental request.

19. The non-transitory computer-readable medium of claim 17, wherein, the instructions when executed by the one or more processors that cause the computing device to provide the user interface configured to manage the at least one experimental request further cause the computing device to receive, from a submitter of the at least one experimental request, information associated with the human resources needed and the robotic resources needed for the at least one experimental request.

20. The non-transitory computer-readable medium of claim 17, wherein, the instructions when executed by the one or more processors that cause the computing device to provide the user interface configured to manage the at least one experimental request further cause the computing device to receive, from a submitter of the at least one experimental request, one or more modifications to the at least one experimental request.
